(19) United States
(12) Patent Application Publication
(10) Pub. No.: US 2018/0032964 A1
(43) Pub. Date: Feb. 1, 2018

(54) TRANSPORTATION SYSTEM AND METHOD FOR ALLOCATING FREQUENCIES OF TRANSIT SERVICES THEREIN

(71) Applicants: NEC Europe Ltd., Heidelberg (DE); Delft University of Technology, Delft (NL)

(72) Inventors: Konstantinos Gkiotsalitis, Frankfurt (DE); Oded Cats, Rotterdam (NL)

(21) Appl. No.: 15/439,979

(22) Filed: Feb. 23, 2017

Related U.S. Application Data
(60) Provisional application No. 62/369,232, filed on Aug. 1, 2016.

(51) Int. Cl. G06Q 10/10; G01C 21/34; G08G 1/00; G06N 3/12; G08G 1/127

(52) U.S. Cl. CPC G06Q 10/1093; G06N 3/126; G08G 1/127; G08G 1/202; G01C 21/3415

(57) ABSTRACT

A method of dynamically allocating frequency settings of a transit service includes utilizing AVL/APC to determine travel time and demand variations within a day. Clusters of time periods are formed based thereon and the day is split up. For each of the time periods for which a new frequency setting will be allocated, frequency allocation ranges are computed within which waiting times at multi-modal transfer stops are reduced and a frequency allocation is selected using criteria including passenger demand coverage and operational costs reduction. A plurality of frequency setting solutions are computed using a Branch and Bound approach with Sequential Quadratic Programming (SQP) or a sequential genetic algorithm with exterior point penalization. Sensitivity of the frequency setting solutions is tested to determine a most operationally reliable frequency setting solution for the new frequency setting and a timetable of the transit service is updated accordingly.

### CROSS REFERENCE TO RELATED APPLICATIONS

This application claims priority to U.S. Provisional Patent Application No. 62/369,232, filed on Aug. 1, 2016, which is hereby incorporated by reference in its entirety herein.

### FIELD

The present invention relates to a method for allocating frequencies of transit services, such as public transportation systems, to a computer system for allocating the frequencies, to electronic displays with dynamically updateable service schedules and to a transportation system comprising a plurality of vehicles implementing the method.

### BACKGROUND

Public transport (e.g., bus, trains, metro, trams) operators need to continuously update service frequencies to cater for changes in traffic conditions and passenger demand in both space and time. Bus services are of particular interest since their significant travel time variations due to road traffic strongly affect their service performance. Bus line frequencies can be adjusted to the passenger travel needs subject to resource capacities while operating under reasonable operational costs. In the public transport planning process, frequency setting follows the design of the bus network and precedes timetable design and vehicle and crew scheduling. Methods to determine bus frequencies are based on either passenger load profile rule-based techniques or on minimizing passenger and operator costs (see Ibarra-Rojas, O, F. Delgado, R. Giesen, and J. Mũnoz, “Planning, operation, and control of bus transport systems: A literature review,” Transportation Research Part B: Methodological, 3 Vol. 77, 2015, pp. 38-75). Common practice in public-transit planning is to determine the service frequency based on accumulated hourly passenger counts, average travel time and vehicle capacity. An example can be found in Hadas, Y. and M. Shnaiderman, “Public-transit frequency setting using minimum-cost approach with stochastic demand and travel time,” Transportation Research Part B: Methodological, Vol. 46, No. 8, 2012, pp. 1068-1084 which presents a frequency setting strategy that utilizes Automatic Vehicle Location (AVL) and Automatic Passenger Counting (APC) data for considering also the (a) empty-seat driven (unproductive cost) and (b) the overload and un-served demand (increased user cost) at the frequency setting optimization problem.

Fan, W. and R. B. Machemehl, Tabu in “Search strategies for the public transportation network optimizations with variable transit demand,” Computer-Aided Civil and Infrastructure Engineering, Vol. 23, No. 7, 2008, pp. 502-520 considered finally stochastic parameters such as demand, arrival times, boarding/alighting times, and travel times. Those works take into account multiple factors for setting the bus frequencies over different time periods of the day which result to static timetables and are the outcome of the tactical planning phase of bus operations (an example is presented in Table 1 considering the simplistic case of a bus operator who operates only four services for demonstration purposes).

TABLE 1
Bus frequency allocation for weekdays and weekend days in the
simplified case of four bus services, wherein the day periods
are split in a pre-defined, fixed and static manner.

| | Bus Headways on Weekdays | | | | Bus Headways on Weekend | | | |
|---|---|---|---|---|---|---|---|---|
| | (Monday-Friday) | | | | (Monday-Friday) | | | |
| Period of | Bus | Bus | Bus | Bus | Bus | Bus | Bus | Bus |
| the Day | Service 1 | Service 2 | Service 3 | Service 4 | Service 1 | Service 2 | Service 3 | Service 4 |
| Morning | 6 min. | 7 min. | 9 min. | 10 min. | 8 min. | 9 min. | 11 min. | 15 min. |
| Peak | | | | | | | | |
| Midday | 5 min. | 8 min. | 10 min. | 9 min. | 8 min. | 12 min. | 12 min. | 12 min. |
| Time | | | | | | | | |
| Afternoon | 7 min. | 6 min. | 6 min. | 7 min. | 9 min. | 9 min. | 8 min. | 9 min. |
| Peak | | | | | | | | |
| Night | 9 min. | 8 min. | 7 min. | 10 min. | 12 min. | 12 min. | 9 min. | 15 min. |
| Time | | | | | | | | |

In Table 1, the allocated frequency of 6 min. for bus service 1 during the morning peak means that all consecutive bus trips of bus service 1 at that time period are planned to depart from the depot station with a planned headway of 6 minutes. Allocating bus frequencies in an urban area is an exercise of finding a trade-off between multiple bus services (in the range of dozens or hundreds) based on the passenger demand for each bus service and its variation during the day, the travel times of services, the cost of bus operations including the available number of buses and other factors strictly linked to them.

### SUMMARY

In an embodiment, the present invention provides a method of dynamically allocating frequency settings of a transit service which includes utilizing Automatic Vehicle Location (AVL) and Automated Passenger Counting (APC) data so as to determine travel time and demand variations within a day. Clusters of time periods within the day are formed based on the determined travel time and demand variations and the day is split into the time periods. For each of the time periods for which a new frequency setting will be allocated, frequency allocation ranges are computed within which waiting times at multi-modal transfer stops are reduced and a frequency allocation is selected using criteria including at least a passenger demand coverage and an operational costs reduction. A plurality of frequency setting solutions are computed using a Branch and Bound approach with Sequential Quadratic Programming (SQP) or a sequential genetic algorithm with exterior point penalization. Sensitivity of the frequency setting solutions is tested against different travel time and demand scenarios so as to determine a most operationally reliable frequency setting solution. The most operationally reliable frequency setting solution is provided as the new frequency setting to a command center of the transit service. A timetable of the transit service is updated to include the new frequency setting.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically shows an automated bus dispatcher according to an embodiment of the invention utilizing allocated frequencies from day-time splitting for every bus line;

FIG. 2 shows day-time splitting in different time periods after clustering based on the observed demand/travel time patterns from all bus services in the network of the operational area;

FIG. 3 shows electronic displays at bus stations which update their content every day and show (i) the time-splitting of the day into different time periods and (ii) the expected frequency for each bus service accommodating that station

FIG. 4 shows weight factor W₄ ranges within which the optimal frequency allocation remains stable;

FIG. 5 shows a penalty function reduction by replacing the weak frequency allocation solutions with superior ones;

FIG. 6 shows convergence time of the proposed sequential genetic algorithm based on exterior point penalization against exact optimization according to an embodiment of the invention;

FIG. 7 illustrates a method of determining and displaying frequency allocations of buses at stations in a dynamic manner;

FIG. 8 is a network representation of central bus lines in Stockholm;

FIG. 9 is graph showing an enumeration of all discrete solutions for a frequency setting problem;

FIG. 10A shows frequency setting solutions according with a Branch and Bound approach including a scalar objective function;

FIG. 10B shows frequency setting solutions according with a Branch and Bound approach including discrete frequency settings with iterations;

FIG. 11A shows determinations of sensitivity of optimal frequency setting solutions including frequency settings sensitivity to passenger demands at stop level;

FIG. 11B shows determinations of sensitivity of optimal frequency setting solutions including frequency settings sensitivity to passenger waiting variability; and

FIG. 12 shows determined effects of frequency setting changes to i) waiting time variability, ii) passenger demand coverage, iii) operational costs and iv) cost relating to adding additional buses.

### DETAILED DESCRIPTION

In an embodiment, the present invention provides improvements in transportation systems. For example, transport operators are able to request further actions on the frequency settings field for the improvement of (i) bus frequencies' flexibility to the changes on traffic congestion and passenger demand, (ii) the exploitation of frequency settings capabilities on improving bus operations and/or (iii) better use of resources (crew, fleet and kilometres travelled).

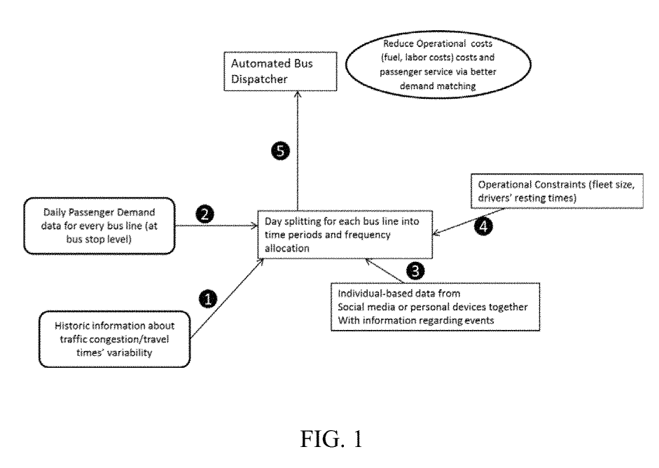

In contrast to known solutions, an embodiment of the present invention provides a solution to the frequency setting problem which advantageously takes into account consequences of travel time and demand variability during (a) each single day of the year; and (b) during different time periods within those days. Service reliability is mostly addressed at the operations control phase by re-adjusting planned schedules or applying control measures such as bus holding (see Gkiotsalitis, K. and N. Maslekar, “Improving Bus Service Reliability with Stochastic Optimization” Intelligent Transportation Systems (ITSC), 2015 IEEE 18th International Conference on, IEEE, 2015, pp. 2794-2799). However, the inventors have recognized that consideration of service reliability already at the tactical planning phase can potentially generate solutions that tackle the inherent uncertainty of public transport operations which is particularly high at dense metropolitan areas. In addition, other aspects such as the coordination of bus lines between them and with other mobility services is not addressed during the frequency setting phase even if it can lead later to high passenger waiting time levels at bus transfer stations. Finally, the allocation of different frequencies during different fixed periods of the day (i.e., morning, afternoon, evening) does not offer enough granularity for exploiting fully the utilization of resources (crew, fleet and kilometres travelled). According to an embodiment of the invention, a system including an automated bus dispatcher for tackling those issues is presented in FIG. 1.

As shown in FIG. 1, day splitting for each bus line into time periods and allocating frequency settings for those time periods is performed by one or more computer processors implementing the method for allocating frequency settings in accordance with any of the embodiments of the invention described herein. The day splitting is performed based on account historic information 1, daily passenger demand 2, data from individual devices or social media 3 and/or operational constraints 4 in accordance with different embodiments. As an output 5, the automated bus dispatcher applies any new frequency setting allocations. The automated bus dispatcher can be, for example, a dedicated server at a command center which, upon receiving new frequency setting allocations, can apply the new frequency settings to new or existing electronic timetables stored in memory or on the web, alert drivers or buses of frequency changes and providing instructions and new or adapted routes as applicable, update electronic displays at the bus or transit stops or on the buses themselves (e.g., a route number where a route is adapted), provide e-mail notifications or text alerts to users or user devices, provides instructions for adding or removing buses from the fleet, etc. so that the new frequency settings can be implemented in a rapid and efficient manner in the transit system by the command center, in an automated fashion. As discussed herein, the benefit of allocating new frequency settings in accordance with embodiments of the present invention have been shown to result in reduced computational costs to determine more optimal frequency settings, thereby effecting a direct improvement of the operation of the computer systems of the command center. Moreover, the day time splitting with allocated frequency settings results in reduced operational costs of the transit system and decreased passenger waiting times, thereby effecting improvements in the transit system itself.

In an embodiment, the present invention provides a method for dynamically setting the frequencies of transit services in a city network with a specific focus on bus services for which the operational travel time variations are more significant. Demand/travel time patterns of each bus service in the city network can be considered together with individual level information from cellular/social media data or higher-level information regarding traffic disruptions, events, etc. to dynamically split the day into different time periods and allocate the frequencies of buses within those periods achieving a better utilization of resources (vehicles, crew). Coordination with other emerging mobility services can also considered by allocating frequencies that reduce the waiting times of passengers at transfer points between bus and other mobility services. Finally, operational variations can be taken into consideration by allocating frequencies based on operational reliability. By doing so, the allocated frequencies are less susceptible to travel time/demand variations during daily operations.

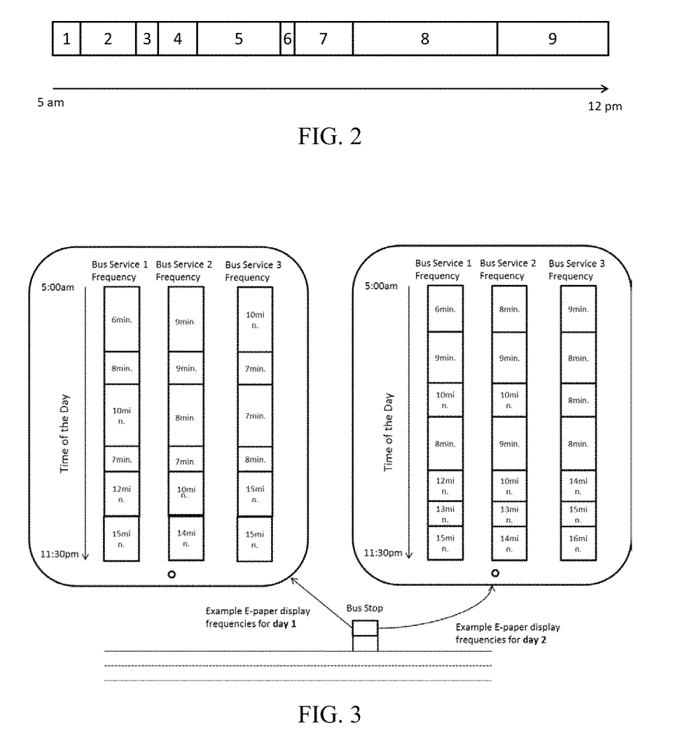

According to an embodiment of the present invention, an automated dynamic splitting of time periods of different days based on demand/travel time variation probability distance of all bus services is performed for allocating different frequencies at those periods. This means that different days might be split in different time periods as presented in FIG. 2. As an initial step, the demand and travel time records of one day are utilized for all bus services in a city network. Then, the demand and travel time patterns are analyzed to find the time periods of the day within which the travel time and demand variations at all bus services are relatively homogeneous and apply clustering (different time periods of the day are clustered by comparing the distance between the travel time variation values and the demand variation values).

Let Tₗ={Tₗ_{_{,1}}, Tₗ_{_{,2}}, . . . , Tₗ_{_{,z}}} be the round-trip travel time of bus line l at different time instances of the day where those instances are denoted as: (1,2, . . . , z). Let also Dₗ={D_{l,1},D_{l,2}, . . . , D_{l,z}} be the passenger demand for line l at those time instances. If L is the total number of bus lines at the city network, then clusters are developed by splitting the day into time periods based on the round-trip travel time variance and the demand variance. Initially, there is only one cluster (the initial cluster). This cluster contains only the first time instance from the set (1,2, . . . , z). Its travel time variance and demand variance is always equal to zero according to the following equations:

$$Travel Time Variance ( 1 ) = \frac{{\sum }_{l = 1}^{L} {\sum }_{k = 1}^{1} {( ( {T}_{l , 1} ) - ( {T}_{l , k} ) )}^{2}}{L}$$

$$Passenger Demand Variance ( 1 ) = \frac{{\sum }_{l = 1}^{L} {\sum }_{k = 1}^{1} {( ( {D}_{l , 1} ) - ( {D}_{l , k} ) )}^{2}}{L}$$

However, the initial cluster is populated in a sequential manner with more elements. Following the sequence, travel time and the passenger demand variance of all bus lines are calculated after considering the second time instance:

$$Travel Time Variance ( 1 , 2 ) = \frac{{\sum }_{l = 1}^{L} {\sum }_{k = 1}^{2} {( ( {T}_{l , 1} + {T}_{l , 2} ) / 2 - ( {T}_{l , k} ) )}^{2}}{2 * L}$$

$$Passenger Demand Variance ( 1 , 2 ) = \frac{{\sum }_{l = 1}^{L} {\sum }_{k = 1}^{2} {( ( {D}_{l , 1} + {D}_{l , 2} ) / 2 - ( {D}_{l , k} ) )}^{2}}{2 * L}$$

This procedure continuously considers at each sequence the 3^{rd}, the 4^{th} the 5^{th} etc . . . time instances. The 1^{st} cluster is closed and is not accepting more time instances when at one sequence (e.g., the 5^{th} time instance) the travel time variance is bigger than a pre-defined travel time variance threshold value (TTV) or the passenger demand variance is bigger for the first time than a pre-defined threshold value (PDV). The threshold values for the acceptable travel time variance, TTV, and the passenger demand variance, PDV, ensure that the travel times and the passenger demand within the cluster are homogeneous and have, at the worst case, variance equal to the TTV and PDV values. The time period of the 1^{st} cluster then is the time difference between the 1^{st} and the 4^{th} time instance since the 5^{th} time instance violated one of the variation threshold values.

After closing the 1^{st} cluster, a 2^{nd} cluster is started and its first member is the time instance that violated the TTV or the PDV threshold (in our example, the 5^{th} time instance). This cluster is populated with time instances again in a sequential manner until again one of the threshold values of TTV or PDV are violated. Then, the 2^{nd} cluster is closed and a 3^{rd} one is started and the procedure continuous until we reach the final time instance of the day (time instance z). Results of the split of one day into clusters (time periods) are presented in FIG. 2. To automate this approach even when the threshold values TTV, PDV are not known, threshold-free clustering with the use of the Density-based algorithm for applications with Noise (DBSCAN) can be deployed.

As shown in FIG. 2, those periods significantly differ from the fixed time periods shown in Table 1 for a conventional frequency allocation. For example, the typical morning peak-midday-afternoon peak-night time split is not used in the embodiment of FIG. 2. Rather, the time split is defined and updated automatically based on the clustering approach of the observed demand/travel time patterns at that day. For this reason some periods like period 6 in FIG. 2 are distinctively small, while others, such as period 8, are relatively much longer since the demand/travel time variations of all services remained stable at that period. Preferably, according to an embodiment, it is particularly advantageous that the time period allocation changes from day to day. For example, on another day, the exact same procedure is performed and another time period split is assigned. This procedure is preferably performed continuously or daily for all days of the year. One key benefit of this approach is the setting of frequencies in a higher granularity environment where different frequencies are set for different time periods. In this manner, it is advantageously ensured that each time period is served in a more optimal way, thereby avoiding under or over-utilization of resources (e.g., crew, fleet and kilometres travelled). In other words, this dynamic time-period allocation ensures that a better trade-off on allocating resources among different bus services is achieved.

In another embodiment, electronic devices, such as displays, are provided for placement at individual transit stops. Such devices can replace the known static paper-format timetables at bus stations. Those electronic devices are specially adapted to utilize the method according to an embodiment of the present invention or receive update instructions from a central computer system implementing the method in order to dynamically display updated travel frequencies and/or connections. In other words, such devices can be updated to show the expected bus frequency for every time period of the day, for example, such that a passenger can be informed from the beginning of the day about the time period splits within the day and the bus frequency allocated to each bus service at the city network. For instance, if one station is served by three bus services, as in FIG. 3, then the electronic device can display the daily time splits and the allocated frequencies for each service. This data will preferably change from day to day based on the results from the tactical planning of each day as shown in FIG. 3.

In contrast to known methods for frequency allocation which simply consider criterion from the standpoint of the fundamental trade-off between passenger satisfaction and operational cost reduction, an embodiment of the present invention provides that coordination criterion (such as demand coverage, reduction of costs (kilometers traveled and utilized buses), passenger waiting times at stations, occupancy levels, overloads etc.) are considered by giving preference to frequency settings that not only achieve a trade-off between passenger demand and operational costs, but also improve the transfer waiting times of passengers who are willing to perform a multi-modal journey (e.g., (a) transfer from a bus service to another mobility service such as car sharing, and vice versa; (b) transfer from a bus service to another bus service; and/or (c) transfer from a bus service to a train service, and vice versa). The latter criterion reduces specifically the total travel time of passengers' multi-modal journeys and improves the integration of bus with other emerging mobility services by mitigating the wasted waiting times issue during mode transfers.

For performing the foregoing procedure according to one embodiment, a multi-criteria objective function is provided which considers the foregoing priorities. Different priorities, such as the demand coverage, might have higher value for the bus operator. For this reason, weight factors are provided that give more importance to some criteria at the expense of others, for example according to the bus operators' preferences. Therefore the frequency setting optimization problem over a time period of one day can be expressed as:

$$min {f}_{p} ( x 1 , … , xn ) = {W}_{1} * DemandCoverage ( x 1 , … , xn ) + {W}_{2} * OperationalCosts ( x 1 , … , xn ) + {W}_{3} * ExcessWaitingTimes ( x 1 , … , xn ) + {W}_{4} * Transfer\_Waiting \_Times ( x 1 , … , xn )$$

where fₚ(x1, . . . , xn) is the scalar objective function for time period p that has multiple priorities such as the coverage of passenger demand, reduction of operational costs, reduction of passenger excess waiting times and improvement of services coordination in the form of transfer waiting times. The objective is to find the optimal frequency for each bus service x1, . . . , xn operating within this time period by minimizing this objective function where all priorities have a different weight factor W₁, . . . , W₄ which can be determined based on the preferences of the bus operators in the city.

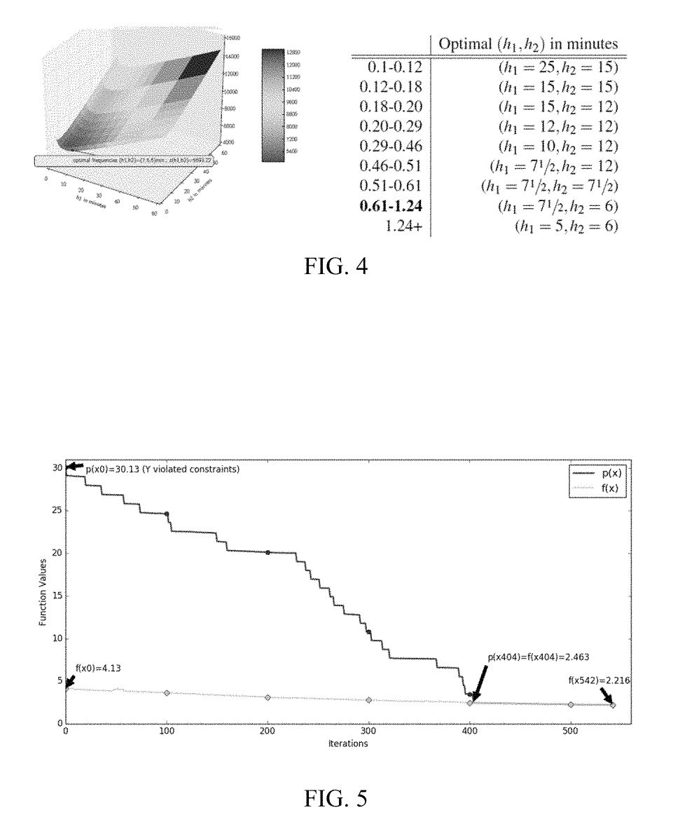

At some day periods, the inventors have recognized that the coordination weight, W₄ might have too limited importance to the frequency allocation (e.g., even if the W₄ value is too high, the allocated frequencies does not change significantly), while at other day periods each small change to weight W₄ might lead to objective function, fₚ(x1, . . . , xn), over-penalization and significant inefficiencies on covering the passenger demand and reducing the operational costs only for having small improvements at transfer waiting times. Therefore, in an embodiment, the present invention re-optimizes the frequency allocation problem for different values of weight W₄ for identifying the frequency allocation sensitivity to weight factor W₄ changes. In this way, different value regions (“envelops”) are located within which the frequency allocation remains the same or generally stable subject to changes to the W₄ values. For instance, in the simplified case of two bus services, those regions after successive re-optimizations of the objective function subject to different W₄ values are presented in FIG. 4.

Those weight factor ranges can be particularly important to the service operator because they offer information about how much to value the transfer time reduction for not over-penalizing the service operations (running costs/demand coverage).

According to an embodiment of the present invention, the method does not stop after finding the optimal frequency for each bus service within the examined time period, but rather moves a step further by ignoring the optimal solution if it does not perform well in real-world operations. The optimal frequency setting and the optimal frequencies selected according to known approaches focus on finding the best trade-off between passenger demand coverage and operational costs for allocating resources in an optimal way. However, the inventors have recognized that this approach might return a solution which is too sensitive to operational changes. For example, the planned optimal frequency setting allocation might not yield a good performance on the field even in the case of the slightest disruptions of the real-world operations (e.g., slight traffic or passenger demand differences from the expected traffic/demand). To tackle this dynamicity, an embodiment of the present invention moves a step further and identifies the most reliable solution, which is preferably the first solution close to the optimal one that is stable against operational changes. However, for performing such action, multiple solutions of the frequency allocation problem are preferably computed for identifying those sensitivities.

The frequency allocation problem modeled as a minimization problem of a scalar objective function is in practice computational intractable due to the nonlinear form of the objective function and the presence of several nonlinear constraints such as the constraint of the total number of buses (i.e., allocated frequencies should ensure that the required buses are always less or at most equal to the total number of available buses). If any bus service can have a frequency from the range {2, 4, 5, 7, 8, 9, 10, 12, 15, 20, 30, 45, 60} minutes, which is a typical set of bus frequencies and a city has 100 bus services, then 13¹⁰⁰=2.479E+111 computational operations are required for allocating the optimal frequency at each service. Exact numerical optimization for non-linear programming such as Sequential Quadratic Programming (SQP) or Augmented Lagrangian coupled with discrete optimization techniques such as Branch and Bound also fail to compute the global optimum solution in such a rapid manner. Also, the identification of the frequency setting allocation sensitivity to operational changes requires the computations of dozens or hundreds of solutions which can be considered prohibitive in some situations due to the severe computational time costs.

To address these complexities, an embodiment of the present invention advantageously introduces a sequential genetic algorithm based on exterior point penalization for approximating the most reliable (less susceptible to operational changes) frequency allocation of bus lines with polynomial computational cost instead of exponential. At a first step, we utilize a penalty for all constraints, cₚ(x1, . . . , xn), and we replace the objective function, fₚ(x1, . . . , xn), with a penalty function Pₚ(x1, . . . , xn) that approximates the constrained optimization problem with an unconstrained one:)

min Pₚ(x1, . . . , xn)=fₚ(x1, . . . , xn)+W*max(0; cₚ(x1, . . . , xn))²

where cₚ(x1, . . . , xn) is the value of the constraints for the frequency allocation x1, . . . , xn and is greater than zero if constraints are not satisfied and lower or equal to zero if constraints are satisfied. The term W*max (0; cₚ(x1, . . . , xn))² penalizes all non-satisfied constraints without penalizing any unsatisfied constraint and the weight factor W secures that satisfying all constraints is more important than minimizing the objective function fₚ(x1, . . . , xn).

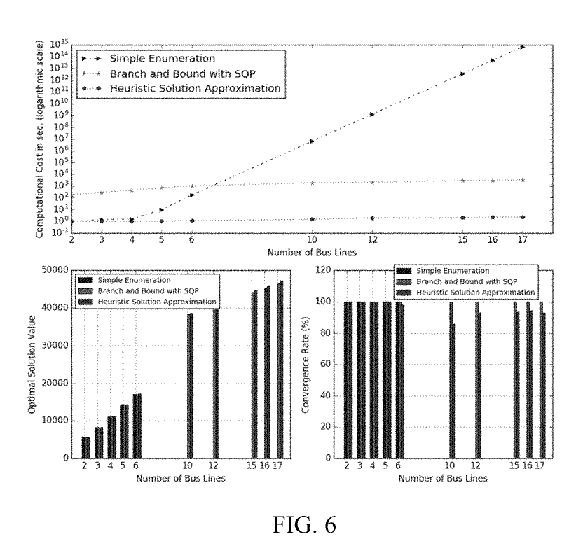

If at a time period where it is needed to set the bus frequencies of n=50 bus services, then the unknown frequency setting of each bus service is represented by the descriptive variables x1, x2, . . . , x50. First, a set x′={x′1, x′2, . . . , x′50} is introduced where each one of the frequency setting values x′1, x′2, . . . , x′50} takes a totally random value from the {2, 4, 5, 7, 8, 9, 10, 12, 15, 20, 30, 45, 60} minutes which contains all possible bus frequencies in practical applications. Then, a second set x″={x″1, x″2, . . . , x″50} is introduced where again each x″1, x″2, . . . , c″50 value is a totally random value from the {2, 4, 5, 7, 8, 9, 10, 12, 15, 20, 30, 45, 60} minutes. A third set x′″={x′″1, x′″2, . . . , x′″50} is introduced in the same way. The, sequential crossover is performed in which the penalty function is computed for the randomly chosen service frequencies x′: f(x′) and x″: f(x″) and the one with the minimum penalty function score is selected as the best one. It is assumed for now that this is x″: f(x″)). Then, the weak solution is x′: f(x′). After that, one element is selected from random set x′″={x′″1, x′″2, . . . , x′″50} (for this example, x″2 is selected) and it is determined whether f(x′″={x′″1, x′″2, . . . , x′″50} value is reduced if x′″2 is replaced with the second element of set x′: x′2 or the second element of set x″: x″2. If it is indeed reduced, then x′″ is updated by replacing its second element with the one from the other two sets which reduced f(x′″) the most. A small probability (e.g., 10% mutation rate) that x′″2 takes another value from the set {2, 4, 5, 7, 8, 9, 10, 12, 15, 20, 30, 45, 60} minutes can be allowed instead of trying only the values from the other sets (in this example, the x′2 and x″2 sets). Then, after having finished with searching replacements of x′″2 for reducing the objective function score of x′″, the same procedure can be continued for all elements x′″1, x′″2, . . . , x′″50. If at any point the score of f(x′″) is lower than the score of the weak solution which was assumed as the set x′, the whole set x′ is replaced with x′″. By doing so, sets x′, x″ update continuously their frequency setting values by finding new frequency settings that improve further the objective function ƒ until a point is reached where further improvements are not possible. At this point, the mutation probability of x′″2 is increased taking a value from the set {2,4,5,7,8,9,10,12,15,20,30,45,60} minutes (e.g., from 10% to 70%) in order to explore other parts from the solution space. If still no improvement is observed, an approximate global minimum is reached which is a close approximation to the optimal solution of the multi-objective frequency setting problem. The approximate global optimum satisfies all constraints if the continuous reduction of the penalty function score reached a point where the penalty function and the objective function scores had equal values as shown in FIG. 5. After that point, each penalty function reduction resulted in an equal objective function reduction. In the example of FIG. 5, all constraints are satisfied at the 404^{th} replacement and the penalty function score is equal to the objective function for the first time.

The foregoing procedure can be performed, for example in accordance with the following pseudocode:

```
x = (x[1],x[2],...,x[n]) = random vector of length n #this is parent A
x′ = random vector of length n #this is parent B
while(improvements are found)
{
      x″ = random vector of length n #this the offspring
      for each i = 1...n {
            k = x″[i]
            with probability p, assign x″[i] a random new value
            #mutation step
            with probability 1−p, assign x″[i] a value among
{x[i],x′[i],x″[i]} minimizing the penalty #crossover step
      if P(x)>P(x′) and P(x)>P(x″)
            replace x with x″
      else if P(x′) > P(x) and P(x′)>P(x″)
            replace x′ with x″
      else if P(x′)<P(x″) and P(x)<P(x″)
            return x″[i] to its previous values before the mutation/
crossover: x″[i] = k
      if (some condition holds)
            increase p
      }
}
```

Accordingly, the solution computation is rapid and multiple computations of optimal solutions can be performed by trying every time new potential demand/travel time scenarios and selecting a close to optimal solution which is less susceptible to demand/travel time changes during real-world operations as the preferred frequency allocation. Thus, embodiments of the present invention significantly reduce the above-described computational time costs which would otherwise be necessary, thereby resulting in a system that not only requires less computational resources to allocate frequencies in a more effective manner, but actually can be performed dynamically. Moreover, even using such reduced computation resources, stability against operational changes can also be provided dynamically as often as the updates are desired.

FIG. 6 demonstrates the savings in computational cost using the sequential genetic algorithm (heuristic solution approximation) according to an embodiment of the invention, as compared to the Branch and Bound and SQP approach according to an embodiment of the invention discussed below and a simple enumeration solution, as well as a comparison of optimal solution values and convergence rate for different numbers of bus lines. While the computational costs savings are not as great as with the sequential genetic algorithm approach, it can be seen that the Branch and Bound supplemented with SQP approach at a number of bus lines greater than 6 also achieves relatively constant computational costs that are reduced compared to the simple enumeration approach. It can also be seen that, at a higher number of bus lines, the sequential genetic algorithm approach the Branch and Bound with SQP approach can achieve a higher convergence rate. The data was obtained for seventeen bus lines in Stockholm from the example discussed in greater detail below.

Accordingly, an embodiment using the genetic algorithm with penalization is much faster than the Branch and Bound with SQP thanks to its specific sequential structure and the very small number of population generators that enable the computation of an approximate optimal value in seconds. This, allows its use several times for evaluating different frequency allocation scenarios and selecting the most operationally reliable one. On the other hand, the Branch and Bound with SQP has higher convergence to the optimal solution, but is better suited for use in smaller networks because it is slower and does not scale up as well. Accordingly, the embodiments provide different benefits and effect different improvements to the functioning of the computer system.

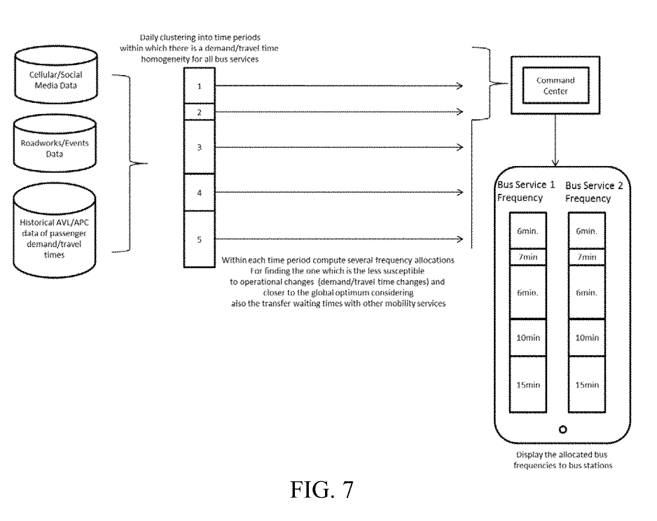

Further, in an embodiment of the present invention, network-level mobility patterns and expected disruption levels are utilized for setting the bus frequencies of future days by mining novel data sources such as smartphone/web data instead of merely considering solely historical AVL/APC data. The utilized data is both qualitative and quantitative and can come from individual users, via cellular or social media generated data, and/or from a more aggregated level indicating road works, demonstrations, city events, etc. This data is utilized to capture with higher accuracy the demand/travel time patterns of future days and perform a higher granularity split of those daily periods. FIG. 7 illustrates how this data can be utilized, for example by a command center including one or more computational processors and/or servers, to dynamically allocate the frequencies and update the relevant displays at the transit stops.

Advantages and improvements provided by embodiments of the present invention include:
1) Automated dynamic splitting of time periods of different days for allocating different frequency settings based on demand/travel times based on AVL/APC data and user-generated cellular/social media data,
2) Automated dynamic splitting of time periods based on the demand/travel times variation probability distance of all bus services in the entire city network,
3) Allocating frequencies using a particular approach that improves also the coordination between bus services and other mobility services by introducing weight factors for waiting times at transfers and establishing ranges that offer information about how much to value coordination at different daily periods for not over-penalizing demand coverage/operational costs,
4) Using a sequential genetic algorithm method based on exterior point penalization for evaluating rapidly (in polynomial time) several expected travel time/passenger demand scenarios and approximating the most reliable frequency allocation which is the least susceptible to performance loss when the travel time/passenger demand on real world operations change,
5) Exploiting the available resources with improved efficiency and offering higher granularity (e.g., utilizing less buses/crew when needed and/or adding more bus trips to bus services in need).
6) Reducing the waiting times for multi-modal journeys,
7) Improving the bus service integration with other mobility services, and/or
8) Providing reliable frequency setting allocations that are less susceptible to operational variations of travel times and demand levels.

According to an embodiment, the method for allocation of dynamic frequency setting of bus and/or other transit services that change from day to day and are less susceptible to operational changes comprises:
1) Utilizing AVL/APC data for capturing demand/travel time spatio-temporal mobility patterns within a day,
2) Forming clusters of time periods based on the demand/travel time variability distance of all bus lines and deriving the time periods for which another frequency setting should apply by splitting the day time into those time periods,
3) Computing frequency allocation ranges within which the waiting times at multi-modal transfer stops are reduced and selecting the optimal frequency allocation trade-off between (a) passenger demand coverage, (b) operational costs reduction and (c) total multi-modal travel times reduction,
4) Computing, rapidly, several frequency setting solutions with the sequential genetic algorithm method based on exterior point penalization and testing their sensitivity against different demand/travel time scenarios,
5) Obtaining the most operationally reliable (less susceptible to operational changes) frequency setting solution and repeating this approach for each time period of the day,
6) Optionally, utilizing cellular/social media data from individual users or other events taking place in the urban area (road works, demonstrations, events) to split the time periods of future days and set their bus frequencies with higher confidence, and
7) Providing the new frequencies to the operations command center and updating the time period slots and the allocated frequency values for each bus line.

Embodiments of the present invention can utilize, and/or the setting of frequencies can be verified, using General Transit Feed Specification (GTFS) data.

In the following, a further embodiment is described which focuses on the Branch and Bound and SQP approach, but this discussion is also relevant the embodiment using the sequential genetic algorithm discussed above, especially with regard to an example using Stockholm bus lines for which results are presented for both embodiments (see FIG. 6). The problem is formulated as a non-linear discrete programming problem with non-linearity also in the constraints and a solution method is discussed based on Branch and Bound and SQP approach. The performance of the proposed approach is tested using data from seventeen central bus lines in Stockholm. Experimental results demonstrate (a) the improvement potential of the base case allocated frequencies; (b) the sensitivity of different criteria, such as passenger demand coverage, to frequency allocation changes and (c) the accuracy of the proposed solution method compared to a heuristic approach. A reliability-based optimization frame-work for is developed and applied for bus frequency settings. In the following, the problem description is presented again considering the demand variations and the travel time variability from bus stop to bus stop over time. In addition, the multi-objective frequency setting problem is formulated. Then, an exact solution method for solving the discrete non-linear programming bus frequency setting problem is described. The method is applied by using GTFS data from the seventeen central bus lines in Stockholm and detailed AVL and APC data from central bus lines 1 and 3. The optimization framework is evaluated in terms of solution accuracy while assessing its computational requirements.

Let us assume a bus network with L={1, 2, . . . , L} bus lines and S={1, 2, . . . , S} bus stops. Let also a series of vectors Sₜ={1, 2, . . . , Sₜ} denote the bus stops belonging to each bus line l ∈ L where the bus stops of each line are arranged in a consecutive order starting from the departure station. Service frequency (departure per hour) of line l is defined by the planned headway: fₜ=60/h_{l,planned}. Due to service variability, actual headways may deviate from the planned headway. h_{l,j} is also the headway of bus line l at stop j ∈ Sₗ.

The travel time on each line segment varies from time to time. For this reason, the total travel time value of a line tttₗ^{90th} is introduced for which there is only a 10% chance for a bus trip of line l to require more travel time than that (according to historical data). Discarding layover and recovery times, the number of buses necessary for operating l can be approximated as follows:

$${q}_{l} = \frac{{ttt}_{l}^{90 th} \cdot {f}_{l}}{60} \qquad ( 1 )$$

However, the total number of trips assigned to every line should be at most equal to the total number of buses available at the network level:

Σ_{l∈L}qₗ≦γ (2)

where parameter γ corresponds to the total number of available buses and is a positive integer. For the objective function of the frequency setting problem, three key components are considered. First, the passenger-related waiting cost at each stop j ∈ Sₗ. For a time period with homogeneous boarding levels b_{l,j} at each bus stop j and the selected bus frequency which determines also the bus headway at the stop j:

$${O}_{1} = \frac{{h}_{l , j}}{2} \times {b}_{l , j} \qquad ( 3 )$$

where h_{l,j}/2 is the planned waiting time at stop j assuming random passenger arrivals at the stop. In this example, the frequency setting problem is considered in the context of high-demand urban areas. Therefore, the frequencies for all lines are sufficiently high so that passengers do not coordinate their arrival with vehicle arrivals (e.g., at least four departures per hour).

Second, the impacts of expected service reliability are considered. In the context of urban bus systems, service variability resulting from road congestion and passenger volumes is an important determinant of passenger waiting time. The excessive waiting time associated with service irregularity is expressed in terms of expected waiting time variation due to headway variance:

O₂=w_{l,j}×b_{l,j}+w_{l,j}×c_{l,j} (4)

where w_{l,j} is the expected waiting time variation at stop j ∈ Sₗ. The expected waiting time variation cost is decoupled because the cost of an unexpected waiting time is experienced as delay and therefore has a more negative impact to passengers than the anticipated waiting time. In addition, in high frequency bus operations in metropolitan areas such as London and Singapore where the reliability operational scheme is adopted (instead of punctuality), the waiting time variances from the planned waiting times at stations have the most importance and penalties/bonuses can be allotted to bus operators according to their adherence level to the planned waiting times. The penalty/bonus monetary costs have different weights at different stops since some bus stops on the network are more important than others (e.g., feeder stations); thus, every stop receives a different bonus/penalty weight c_{l,j}.

Finally, the frequency setting objective function includes the operation costs which can be expressed in terms of vehicle hours:

O₃=qₗtttₗ^{90th} (5)

This cost component includes variable costs such as driver and technical staff, energy consumption and maintenance costs. Additional terms refer to the number of buses that are needed in order to perform the operations:

O₄=δ×(γ−Σ_{l∈L}qₗ) (6)

where δ is the cost of operating an extra bus estimated using the depreciation cost. The latter term is required in order to ensure that solutions deploying fewer buses than the fleet size available will be part of the Pareto front.

The importance of each one of these four objectives (O₁, O₂, O₃, O₄) on the overall bus frequency setting objective function can depend on an operator's management preferences and the operational context (e.g., if reliability is more important, then O₂ has a higher weight; whereas, if operation costs are critical, then O₃ weights more). Weighting factors can be determined based on passenger and operator cost estimates (e.g., value of time, fixed and variable cost units). In the following, a single-objective function is described assuming that these weighting factors are specified, establishing trade-offs between compensatory objective function components:

$$min {\sum }_{l = 1}^{L} {\sum }_{j = 1}^{{S}_{1}} {w}_{l , j} ( {b}_{l , j} + {c}_{l , j} ) + {α}_{1} {\sum }_{l = 1}^{L} {\sum }_{j = 1}^{{S}_{1}} \frac{{h}_{l , planned}}{2} {b}_{l , j} + {α}_{2} {\sum }_{l = 1}^{L} {q}_{l} {ttt}_{l}^{90 th} + {α}_{3} ( δ ( γ - {\sum }_{l = 1}^{L} {q}_{l} ) )$$

subject to:

$$( {q}_{1} , {q}_{2} , … , {q}_{L} ) ∈ {ℕ}^{L} \\ {\sum }_{l = 1}^{L} {q}_{l} \leq γ \\ {h}_{l , planned} = \{ 2 , 3 , 4 , 5 , 6 , 7 \frac{1}{2} , 10 , 12 , 15 , 20 , 25 , 30 , 45 , 60 \} minutes \qquad ( 7 )$$

where alphas are the cost parameters. The number of buses allocated to each line, qₗ for l ∈ L, is an integer value and the planned headway h_{l,planned} among buses at the departure station can be selected from a pre-determined admissible set of values h_{l,planned} ∈ {2, 3, 4, 5, 6, 7 1/2, . . . , 45, 60} in order to adhere to the cyclic bus timetable design requirement.

By considering the variations from the planned waiting time at stations due to the travel time variation, the frequency setting problem is formulated considering also the impact on service reliability. The waiting time variability w_{l,j} of bus line l at station j ∈ Sₗ is a function of the observed headway variability at station j. For instance, if for each bus line l at station j ∈ Sₗ there exists a total number of K headway observations from historical data, {ĥ_{l,j,1}, ĥ_{l,j,2}, . . . , ĥ_{l,j,K}}, between consecutive bus trips; then, w_{l,j} is expressed as:

$${w}_{l , j} = \frac{\sqrt{\frac{{\sum }_{k = 1}^{K} {( {\hat{h}}_{l , j , k} - {\overline{h}}_{l , j} )}^{2}}{K}}}{{h}_{l , planned}} \qquad ( 8 )$$

where

$$\sqrt{\frac{{\sum }_{k = 1}^{K} {( {\hat{h}}_{l , j , k} - {\overline{h}}_{l , j} )}^{2}}{K}}$$

is the observed headway variation at station j and ĥ_{l,j}={ĥ_{l,j,1}, ĥ_{l,j,2}, . . . , ĥ_{l,j,K}} the headway observations for bus trips of bus line l at station j derived from historical data. Finally,

$${\overline{h}}_{l , j} = \frac{{\sum }_{k = 1}^{K} {\hat{h}}_{l , j , k}}{K} .$$

Replacing the waiting time component, w_{l,j}, the frequency setting problem takes the following form:

$$\begin{matrix}z ( {h}_{l , planned} ) = {\sum }_{l = 1}^{L} \frac{1}{{h}_{l , planned}} ( {\sum }_{j = 1}^{{S}_{1}} ( {b}_{l , j} + {c}_{l , j} ) \sqrt{\frac{{\sum }_{k = 1}^{K} {( {\hat{h}}_{l , j , k} - {\overline{h}}_{l , j} )}^{2}}{K}} + {{α}_{2} ( {ttt}_{l}^{90 th} )}^{2} ) + {α}_{1} {\sum }_{l = 1}^{L} {h}_{l , planned} {\sum }_{j = 1}^{{S}_{1}} \frac{{b}_{l , j}}{2} - {α}_{3} δ {\sum }_{l = 1}^{L} ⌈ \frac{{ttt}_{l}^{90 th}}{{h}_{l , planned}} ⌉ + {α}_{3} δ γ & ( 9 ) \\ subject to \text{:} & \\ {\sum }_{l = 1}^{L} ⌈ \frac{{ttt}_{l}^{90 th}}{{h}_{l , planned}} ⌉ \leq γ & \\ {h}_{l , planned} ∈ q = \{ \frac{2 , 3 , 4 , 5 , 6 , 7 \frac{1}{2} , 10 , 12 , 15 , 20 , 25 , 30 , 45 , 60}{\vert q \vert elements} \} minutes & \end{matrix}$$

where

$$⌈ \frac{{ttt}_{l}^{90 th}}{{h}_{l , planned}} ⌉$$

is the smallest integer greater than or equal to the computed number of buses for each line

$${q}_{1} = \frac{{ttt}_{l}^{90 th}}{{h}_{l , planned}} .$$

Finding the optimal frequency for each bus line f₁ is a combinatorial problem since any changes in the planned headway of a single bus line affects all other lines; thus, requiring the exploration of an exponential number of combinations |q|^{L} for calculating the optimal solution when examining the entire space with simple enumeration (brute-force). For each combination of planned headways, the value of the objective function has to be calculated and this requires a total number of 2Σₗ₌₁^{L}S₁|q|^{L} computations where |q| is the length of the discrete set q from which a planned headway value can be selected. Due to the exponential time complexity, the problem is computationally intractable and allows an optimal solution search only on small networks with few bus lines.

In more detail, the optimization problem is a constrained Integer Non-Linear Problem (INLP). The objective function is fractional and there is a fractional inequality constraint. In addition, the decision variables can be denoted by the vector h=(h₁, h₂, . . . , hₗ)^{T} where each h_{l,planned}=hₗ takes a value from the discrete set q. In the following, embodiments of the invention which solve this optimization problem are described.

According to an embodiment, a Branch and Bound method is adopted for solving the discrete INLP frequency setting problem by solving a series of relaxed, continuous INLP sub-problems.

First, the discrete INLP problem of Equation (9) is transformed into the continuous INLP problem of Equation (10) by allowing the problem variables to be real numbers. The discrete set of ({2, 3, . . . , 60}minutes) is now used to set boundary constraints. Thereafter, the method of SQP is selected for solving the continuous frequency setting problem:

$$\begin{matrix}{min}_{h ∈ {ℝ}^{L}} z ( h ) & ( 10 ) \\ subject to & \\ {c}_{1} ( h ) = γ - {\sum }_{l = 1}^{L} ⌈ \frac{{ttt}_{l}^{90 th}}{{h}_{l}} ⌉ \geq 0 & \\ {c}_{2} ( h ) = {h}_{1} - 2 \geq 0 & \\ … & \\ {c}_{L + 1} ( h ) = {h}_{L} - 2 \geq 0 & \\ {c}_{L + 2} ( h ) = 60 - {h}_{1} \geq 0 & \\ … & \\ {c}_{2 L + 1} ( h ) = 60 - {h}_{L} \geq 0 & \end{matrix}$$

where z: [symbol] ^{L}→ [symbol] is the scalar objective function and constraints c₂, . . . , c_{2L+1} are the boundary constraints ensuring that all h values are within the limits {2−60}. The set of inequality constraints is l={1, 2,3, . . . , 2L+1} and the total number of constraints is m=2L+1.

SQP generates new iterates of an initial guess variable hₗ₌₀ by solving inequality constraint Quadratic sub-problems (QP) at each iterate k. The SQP solution method is models the current iteration of solution hₖ by a quadratic programming QP sub-problem and then uses the minimizer of this sub-problem to define a new iterate hₖ₊₁ until convergence.

In the case of inequality constraints and given that z and each constraint cᵢ are continuously differentiable at a point hₖ, then if hₖ is a local optimum and the regularity conditions are satisfied at this point there is a Lagrange multiplier vector λₖ with m elements such that the first order necessary Karush-Kuhn-Tucker (KKT) conditions are satisfied:

Stationary Δₕ [symbol] (hₖ, λₖ)=0

Primer Feasibility cᵢ(hₖ) ≧0, ∀i ∈ I={1, 2, 3, . . . , 2L+1} (11)

Dual Feasibility λ_{k,i}≧0, ∀i ∈ I

Complementarity λ_{k,i}cᵢ(hₖ)=0, ∀i ∈ I

where:

[symbol]

(h, λ)=z(h)−Σ_{i∈I}λᵢcᵢ(h) (12)

is the Lagrangian function [symbol] : [symbol] ^{L+m}→ [symbol] of the constrained INLP and at the initial iteration, an initial guess of the Lagrange multipliers λₖ₌₀ is also provided.

To model the current iterate solution hₖ by a quadratic programming QP sub-problem and then use the minimizer of this subproblem to define a new iterate hₖ₊₁ until convergence, a linearization of the constraints is provided since QP problems tackle only linear constraints. This can be modeled by using the current iteration values of the vector hₖ and the Lagrange multiplier λₖ for finding the minimizer p which is a vector of L elements by solving the following QP sub-problem:

$$\begin{matrix}{min}_{p ∈ {ℝ}^{L}} z ( {h}_{k} ) + ∇ {z ( {h}_{k} )}^{⊤} p + \frac{1}{2} p {∇}_{hh}^{2} ℒ ( {h}_{k} , {λ}_{k} ) p & ( 13 ) \\ subject to ∇ {{c}_{i} ( {h}_{k} )}^{⊤} p + {c}_{i} ( {h}_{k} ) \geq 0 , i ∈ I & \end{matrix}$$

where J(h)^{T}=[Δc₁(h), Δc₂(h), . . . , Δcₘ(h)] is the Jacobian matrix of the constraints vector and Δₕₕ² [symbol] (hₖ, λₖ) is the Hessian matrix of the Lagrange function. After solving the above inequality QP problem, the iterate values are updated (hₖ₊₁, λₖ₊₁)=(hₖ+pₖ, λₖ₊₁) where pₖ and λₖ₊₁ are the solution and the corresponding Lagrange multiplier of the inequality QP. Iterations then continue until convergence with convergence criterion the step direction stagnation (e.g., reach at an inequality QP sub-problem where its solution returns p_{P}={0, . . . , 0} which indicates that there is no better direction than the current one).

In order to find the optimal solution of the discrete optimization problem where h values belong to the set q={2, 3, 4, . . . , 60} minutes, a Branch and Bound method is employed. The search space consists of all combinations of elements in the set q={2, 3, 4, . . . , 60} from which the planned headways of all bus lined L in the network can take their values. Brute-force cannot be applied even for a mid-sized bus network. The Branch and Bound method progresses by selecting the node in the tree that has the lowest bound value and solving the restricted continuous frequency setting INLP using SQP by introducing additional equality constraints that dictate a number of continuous variables h to be equal to their already assigned integer values for this node.

The solution of the restricted continuous INLP with {h₁, . . . , h_{g}} already assigned variable values from set q is to bound this node because if branching continues from this node the newly generated sub-problems would return inferior objective function values. Hence, after each Branch and Bound iteration, entire subspaces are discarded for which it has been determined that they cannot contain the optimal solution. For example, if there are no continuous values of the problem variables that can solve this restricted problem, there would also not be any discrete values that provide a feasible solution.

If after a number of Branch and Bound iterations a node is obtained at which all variables h have assigned discrete values from the set q, then a first possible solution of the discrete INLP is obtained. If, later on, another possible discrete solution of the INLP is found with a lower objective function value, then this becomes the currently chosen discrete INLP solution and the procedure continuous until the branching possibilities have been exhausted.

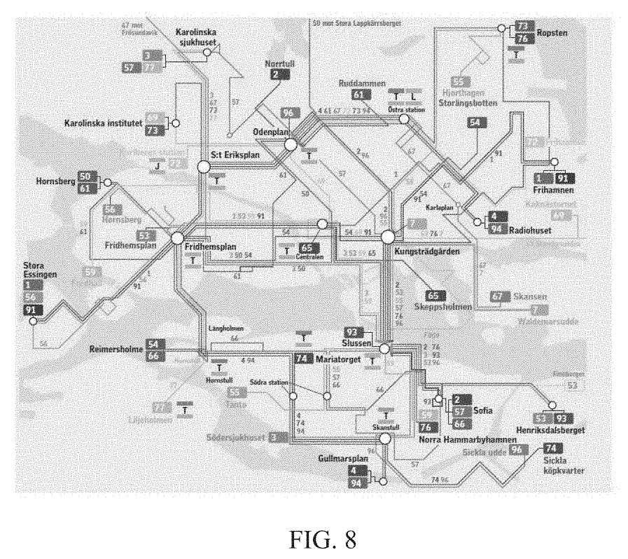

The frequency setting method according to this embodiment using Branch and Bound with SQP was applied to a case study network in Stockholm, Sweden. For deriving the planned schedules of bus routes, a data processing module for converting GTFS data from .txt formal to sql databases was developed in Python. This facilitates data queries and enables the development of web-based applications providing a front-end to the operational control team or command center. The study area is the bus network of central Stockholm which contains 17 bus lines, L={1, 56, 50, 61, 59, 53, 66, 77, 3, 69, 73, 72, 55, 2, 65, 74, 4}. FIG. 8 shows the case study network.

First, two lines are selected for detailed analysis in order to enable the enumeration of all solutions and benchmark the proposed approach against brute-force. Second, we apply our method to 17 lines operating in Stockholm inner-city to test its scalability and performance for a real-sized network.

In this example, a small-scale bus frequency setting demonstration uses data from bus lines 1 and 3, two high demand bus lines in the case study network. Detailed AVL and APC data are available for these lines for a three months period, from August to December 2011. Line 1 connects the main eastern harbor to a residential area in the western part of the city through the commercial center. Line 3 serves as a north-south connection through Stockholm's old city, connecting two large medical campuses. The datasets contain a total number of 1,434 trips and the travel times of each line (per direction) are expressed as mean±standard deviation are presented in Table 2. Table 2 presents also the total number of boarding passengers per line per direction and the 90^{th} percentiles of the total round trip travel times.

TABLE 2
Statistics per line direction. The
values are presented as mean ± s.d.

| | Trip Travel Times | Passenger | Round Trip tttₗ^{90th} |
|---|---|---|---|
| | (sec.) | Boardings | (min.) |
| Line 1, dir. 1 | 3017 ± 425 | 101 ± 50 | 113.27 |
| Line 1, dir. 2 | 2755 ± 480 | 98 ± 51 | |
| Line 3, dir. 1 | 2607 ± 465 | 70 ± 37 | 108.6 |
| Line 3, dir. 2 | 2746 ± 448 | 60 ± 29 | |

The planned headway variables are denoted for each line as h={h₁, h₂} and the bus stations of the bi-directional line 1 are S₁={1, 2, 3, 4, . . . , 65} and of line 3 are S₂={1, 2, 3, 4, . . . , 51}. For the time period 8:00am-2:00pm, there are homogeneous passenger boarding levels at every bus station which are represented by the mean values: {b_{l,1}, . . . , b_{l,65} } for bus line 1 and {b_{l,1}, . . . , b_{l,51}} for bus line 3.

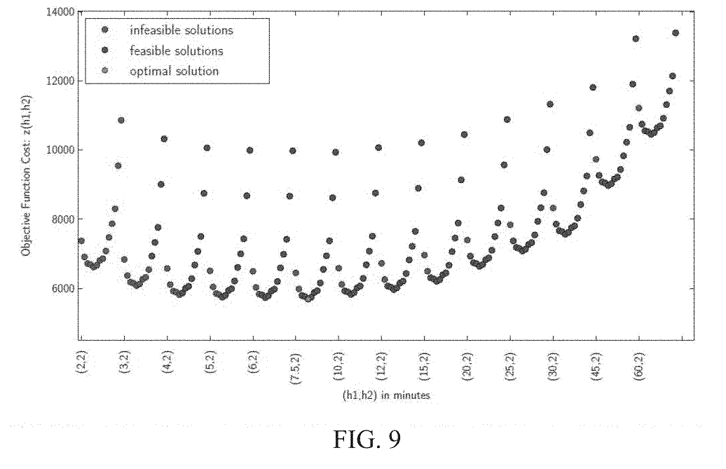

Finally, assuming equal importance of all components of the objective function, the weight factors have the following values: δ=80, a₁=1, a₂=1, a₃=1 and the total number of available buses for serving those two bus lines is based on the current fleet size of γ=44. For this small-scale experiment, an exact frequency setting solution can be computed with simple enumeration after |q|^{L}=196 computations. The result of this optimization is presented in FIG. 9 where the 2D plot enumerates all possible feasible solutions. It can be observed that the solution (h₁, h₂)=(7.5, 6) minutes with z=5693.224 is the global optimum solution by simple inspection.

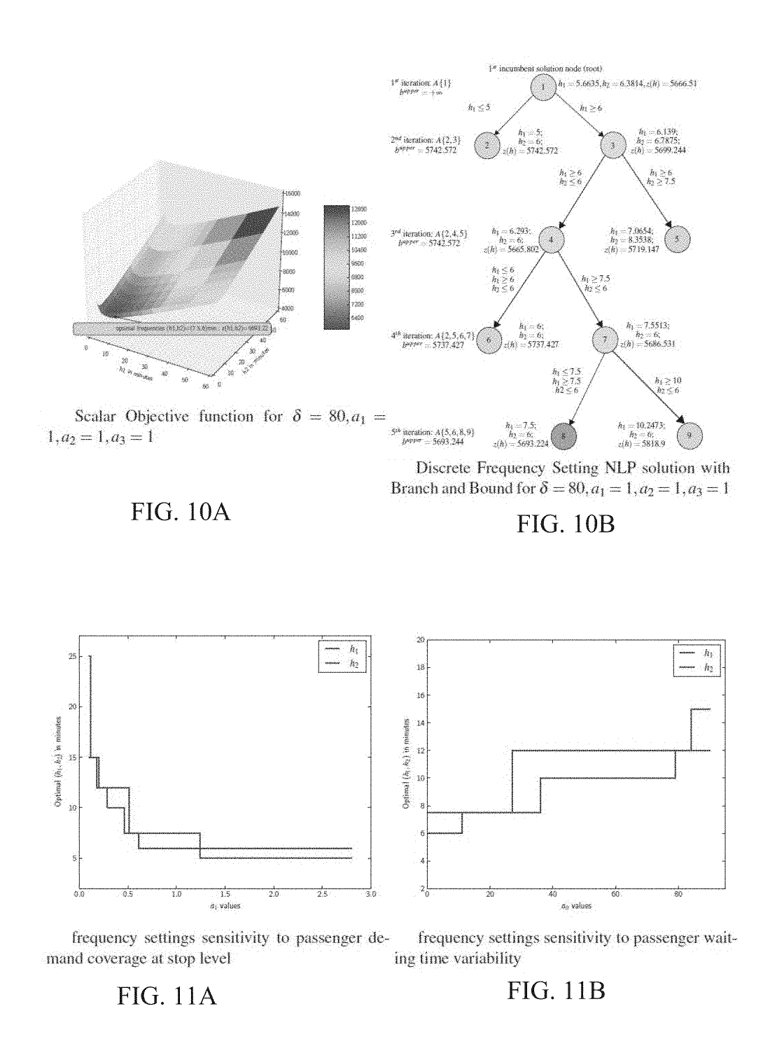

The continuous frequency setting INLP is solved with the SQP algorithmic framework returning solution h*=5.663499, 6.381402 which is the lowest bound of the discrete INLP with z(h*)=5666.51. After three branching iterations presented in FIG. 10B, the Branch and Bound attains a discrete solution (h₁, h₂)=(7.5, 6) with z(h*)=5693.244. The Branch and Bound search terminates after no other branching can result in a better solution. (h₁, h₂)=(7.5, 6) was the frequency setting solution for weight factors values: δ=80, a₁=1, a₂=1, a₃=1 which is also illustrated in the 3D plot of FIG. 10A that presents the shape of the scalar objective function for different planned headway values.

In FIGS. 11A and 11B, the analysis is continued by computing the optimal frequency setting for difference values of the passenger demand coverage weight factor a₁ in order to understand how sensitive the frequency setting solution is to changes in the demand coverage requirements. From FIG. 11A, it can be seen that the frequency setting solution (h₁, h₂)=(7.5, 6) minutes is valid if the weight of the passenger demand coverage is within the range of 0.61-1.24. If its value is lower than 0.61, then the optimal frequency setting values are increased, whereas if the weight is more than 1.24, which indicates that the bus operator places more importance on satisfying passenger demand, then the optimal solution becomes (h₁, h₂)=(5, 6) minutes. Finally, FIG. 11B demonstrates the frequency setting solution sensitivity against changes in the weight factors of the passenger waiting time variability. This weight factor can be represented by a weight a₀ with which the waiting time variation is multiplied at all stops

$$\frac{{\sum }_{k = 1}^{K} {( {\hat{h}}_{1 , 1 , k} - {\overline{h}}_{1 , 1} )}^{2}}{K} .$$

The impact of the optimal solution on passengers and the bus operator is investigated by comparing its implications to the current service as well as examining solutions yield for different weight compositions. The average frequencies used in practice in the operations of the demonstration lines are (h₁, h₂)=(6, 6) minutes, which can be considered as the base case scenario.

Starting from the do-nothing scenario, a one-at-a-time analysis is performed of passenger and bus operator gains by computing the different frequency allocation sets that optimize the i) waiting time variability by setting all other weights to zero: a₁=a₂=a₃=0; ii) the stop-level passenger demand coverage by setting a₂=0, a₃=0,

$$\frac{{\sum }_{k = 1}^{K} {( {\hat{h}}_{1 , 1 , k} - {\overline{h}}_{1 , 1} )}^{2}}{K} = 0 ;$$

iii) the operational (running) costs by setting a₁=0, a₃=0,

$$\frac{{\sum }_{k = 1}^{K} {( {\hat{h}}_{1 , 1 , k} - {\overline{h}}_{1 , 1} )}^{2}}{K} = 0$$

and iv) the number of used buses by setting a₁=0, a₂=0,

$$\frac{{\sum }_{k = 1}^{K} {( {\hat{h}}_{1 , 1 , k} - {\overline{h}}_{1 , 1} )}^{2}}{K} = 0.$$

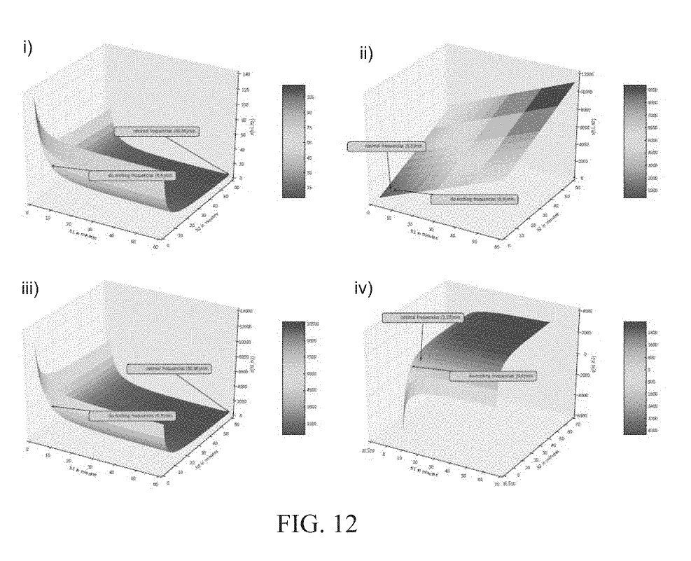

FIG. 12 illustrates how different the results are obtained by the frequency setting for each one of those four scenarios. The analysis provides insights on the sensitivity of passengers/bus operators to frequency setting changes. For all those four scenarios, it is also computed the potential gain of using an optimal frequency setting allocation compared to the do-nothing scenario and those points are plotted in FIG. 12. For scenario i), the optimal frequency setting allocation is F₁ : (h₁, h₂)=(60, 60) minutes, for scenario ii) is F₂ (h₁, h₂)=(5, 6) minutes, for scenario iii) is F₃ (h₁, h₂)=(60, 60) minutes, and for scenario iv) is F₄ (h₁, h₂)=(3, 20) minutes. The currently implemented frequency setting policy in Stockholm is thus close to the optimum when only passenger demand coverage is considered. Some observations are: passenger demand satisfaction is strongly sensitive to any increase in frequency; operational costs do not change much for (h₁, h₂)≧(10, 10) minutes; waiting time variability also does not change significantly for (h₁, h₂)≧(12, 12) minutes and the number of used buses increases more moderately the bus operators' costs for (h₁, h₂)≧(15, 15) minutes, but is penalizing them a lot for (h₁, h₂)≧(4, 4) minutes. In view of these determinations, it is reasonable that any optimal solution for the frequency setting prolem will lie within the range (h₁, h₂)∈{4, 10} minutes.

For the scalability and algorithmic convergence tests, the simple enumeration results were compared against i) the Branch and Bound technique with continuous sub-problem optimization with SQP and ii) the sequential genetic algorithm solution method, as shown in FIG. 6. The scalability and algorithmic convergence tests demonstrate the computational complexity of each solution method and their accuracy level (convergence rare to the global optimum).

The scalability/convergence tests include bigger parts of the central bus network of Stockholm progressively starting from two bus lines and moving up to the seventeen bus lines of FIG. 8. If the objective function z was convex, the proposed SQP method for converging to a solution of the continuous frequency setting INLP by solving quadratic sub-programs that are approximations to the INLP would have converged to the global optimum after finding a local optimum. However, as shown in FIG. 9, the cost function is non-convex and has a series of local minimums. Consequently, the SQP method would converge to a different local minimum depending on the starting point from which it is tried to converge (initial guess). Therefore, it is uncertain if a computed local minimum is also the global minimum and for this a multi-start strategy using large number of initial guesses scattered around the solution space is utilized. By doing this, it is expected that one of those initial guesses would lead to a local minimum convergence which is also the global minimizer. The side-effect of non-convexity is that the SQP method is implemented several times starting from different initial guess points to increase confidence that one of the computed local minimums is also a global minimum.

This metaheuristic multi-start strategy was implemented also for the continuous INLP solutions of FIGS. 10A and 10B. However, for this small scenario, failures to calculate exactly the global optimum of continuous convex INLPs did not affect the quality of the final solution (h₁, h₂)=(7.5, 6) which was the same as the simple enumeration solution. It cannot be guaranteed though that in larger scale scenarios, the Branch and Bound solution method would converge to the global minimizer of the discrete INLP; thus, the convergence tests are expected to provide an indication of the accuracy level of the approach.

The computational performance tests were implemented on a 2556 MHz processor machine with 1024 MB RAM. For the simple enumeration method, only results from 6 bus lines were able to be computed due to the computational complexity and memory exhaustion. For instance, optimizing the entire central bus network of Stockholm requires |q|^{L}=14¹⁷=3.0491347E+19 computations with simple enumeration or 21,461,187 years. In contrast, the proposed Branch and Bound multi-start strategy returns a solution in 55 minutes. This computational time demonstrates its applicability as part of the tactical planning routine. In FIG. 6 the detailed computational cost of simple enumeration and the Branch and Bound with a multi-start strategy and an SQP solver are presented. For this reason, ten test scenarios were devised. Each of these scenarios contains a different number of bus lines in central Stockholm from the set: {2, 3, 4, 5, 6, 10, 12, 15, 16, 17}. The final scenario with 17 bus lines allocates the desired frequencies to all bus lines in central Stockholm. The frequency setting test cases of {10, 12, 15, 16, 17} bus lines or more are computed only with the Branch and Bound and the sequential genetic algorithm solution methods due to the prohibitive computational cost of simple enumeration. Therefore, the computational cost of simple enumeration for 10, 12, 15, 16 and 17 bus lines in FIG. 6 is approximated.

In addition, FIG. 6 demonstrates the objective function scores and the convergence rates of the optimal frequency setting solutions computed attained by simple enumeration (for up to 6 bus lines), the proposed Branch and Bound method and the proposed sequential genetic algorithm, respectively. It is evident that for up to five bus lines, all solution methods converge to the global optimum which is also the solution with simple enumeration. In the case of six bus lines, the sequential genetic algorithm solution is inferior to the global optimum (convergence rate of 97.89%) while the Branch and Bound solution method reaches still a 100% convergence.

For the remaining test-case scenarios of {10,12,15,16,17} bus lines, the level of convergence cannot be necessarily confirmed because simple enumeration cannot be used to validate that the Branch and Bound solutions and the discrete sequential genetic algorithm solutions are the global minimizers. The Branch and Bound solution method managed though to compute planned headway solutions that improved the objective function score 0-18% more than the discrete sequential genetic algorithm solutions.

These results from a real-size network demonstrate that the solution methods according to embodiments of the invention converged to the global optimum and had the same accuracy as brute-force on small-sized bus networks. While sequential genetic algorithm has significantly decreased computational costs, as discussed above, the proposed Branch and Bound method can obtain ˜10% higher accuracy in larger-scale scenarios.

As discussed above, historical AVL and APC data were utilized from two bi-directional bus lines in central Stockholm to set the bus frequencies based on several parameters (passenger demand coverage, waiting time variability at stop level, operational costs, cost of utilizing extra buses) by assigning weight factors to them. Studying the sensitivity of the frequency setting solution, the weight factor values of the problem parameters were changed and new frequency setting solutions were re-computed. The analysis showed that, regardless of the criteria used, optimal frequencies were within the range of {4, 10} minutes in this case study. Finally, ranges were computed within which the frequency setting solution does not need to change even if the service operator changed the values of weight factors of some parameters such as passenger demand coverage and waiting time variability.

Embodiments of the present invention can be used for tactical frequency setting by considering the variabilities during bus operations and/or for identifying the weight factor values range that does not affect each proposed frequency setting solution, thereby allowing the service operator to select solutions that are less sensitive to weight factor changes.

While the method described above determines the frequency for each line separately, assuming that vehicles run back and forth on the same route, information on deadheading, can be used in an embodiment to enhance the fleet allocation flexibility which is especially advantageous in case of strongly directional (i.e., asymmetric) demand. Also, in another embodiment for systems where on-board crowding is an important concern, an additional term can be added to the objective function to penalize heavily-loaded vehicles in order to aim for a fleet distribution that will result with a more equal on-board crowding across the network.

In other embodiments, more constraints can be included, such as the availability of bus drivers together with the associated costs and the analysis of weight factor values based on bus operators' preferences.

The frequency settings determined according to embodiments of the present invention can be used by the devices in the command center to centrally change the frequencies and alert the operators of any changes. New settings can be applied, for example, to online timetables, smartphone applications with access to such timetables and electronic displays, for example, at transit stops. Individual notifications can also be sent to users, for example those users known to be effected by any new transit frequencies. Embodiment of the present invention relate to the command center being configured to implement the methods according to embodiments of the invention, and to electronic displays of timetables which are controlled by the methods/command center, and are thereby dynamically updated.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method of dynamically allocating frequency settings of a transit service, the method comprising:
utilizing Automatic Vehicle Location (AVL) and Automated Passenger Counting (APC) data so as to determine travel time and demand variations within a day;
forming clusters of time periods within the day based on the determined travel time and demand variations and splitting the day into the time periods;
computing, for each of the time periods for which a new frequency setting will be allocated, frequency allocation ranges within which waiting times at multi-modal transfer stops are reduced and selecting a frequency allocation using criteria including at least a passenger demand coverage and an operational costs reduction;
computing a plurality of frequency setting solutions using a Branch and Bound approach with Sequential Quadratic Programming (SQP) or a sequential genetic algorithm with exterior point penalization;
testing sensitivity of the frequency setting solutions against different travel time and demand scenarios so as to determine a most operationally reliable frequency setting solution;
providing the most operationally reliable frequency setting solution as the new frequency setting to a command center of the transit service; and
updating a timetable of the transit service to include the new frequency setting.

2. The method according to claim 1, wherein the transit service is a bus service including bus lines, the new frequency setting being applied to at least one of the bus lines, and wherein the updating is performed by an automated bus dispatcher of the command center.

3. The method according to claim 1, wherein the computing is performed using the sequential genetic algorithm with exterior point penalization.

4. The method according to claim 1, wherein the computing is performed using the Branch and Bound approach with SQP.

5. The method according to claim 1, further comprising displaying the updated time table at an electronic display device at one or more transit stops of the transit service.

6. The method according to claim 1, further comprising increasing or decreasing, for at least one the time periods, a number of vehicles from a fleet of the transit service that are in service based on the updated timetable.

7. The method according to claim 1, further comprising issuing an alert to a vehicle of the transit service on a transit line to which the new frequency setting applies indicating new instructions or a new route to be followed by the vehicle based on the new frequency setting.

8. The method according to claim 1, further comprising utilizing at least one of cellular or social media data from individual users or other events taking place in an urban area of the transit service to split the day into the time periods.

9. The method according to claim 1, wherein the new frequency setting is determined and allocated for each one of the time periods individually such that the updated timetable includes one new frequency setting for each of the time periods.

10. The method according to claim 1, wherein the criteria further include a total multi-modal travel times reduction.

11. A command center comprising one or more computer processors which, alone or in combination, are configured to:
utilize Automatic Vehicle Location (AVL) and Automated Passenger Counting (APC) data so as to determine travel time and demand variations within a day;
form clusters of time periods within the day based on the determined travel time and demand variations and split the day into the time periods;
compute, for each of the time periods for which a new frequency setting will be allocated, frequency allocation ranges within which waiting times at multi-modal transfer stops are reduced and select a frequency allocation using criteria including at least a passenger demand coverage and an operational costs reduction;
compute a plurality of frequency setting solutions using a Branch and Bound approach with Sequential Quadratic Programming (SQP) or a sequential genetic algorithm with exterior point penalization;
test sensitivity of the frequency setting solutions against different travel time and demand scenarios so as to determine a most operationally reliable frequency setting solution;
provide the most operationally reliable frequency setting solution as the new frequency setting to a command center of the transit service; and
update a timetable of the transit service to include the new frequency setting.

12. The command center according to claim 10, wherein the command center is configured to compute the plurality of frequency setting solutions using the sequential genetic algorithm with exterior point penalization.

13. The command center according to claim 10, wherein the command center is configured to compute the plurality of frequency setting solutions using the Branch and Bound approach with SQP.

14. The command center according to claim 10, wherein the command center includes an automated bus dispatcher configured to display the updated time table at an electronic display device at one or more transit stops of the transit service.

15. The command center according to claim 10, wherein the command center includes an automated bus dispatcher configured to electronically communicate an alert to a bus on a bus line of the transit service to which the new frequency setting applies indicating new instructions or a new route to be followed by the bus based on the new frequency setting.
